(19) United States
(12) Patent Application Publication
(10) Pub. No.: US 2026/0298435 A1
(43) Pub. Date: Oct. 1, 2026

(54) ARRANGEMENT OF OPTICAL COMPONENTS FOR A LIGHTING DEVICE FOR A MOTOR VEHICLE AND A LIGHTING DEVICE FOR THE TAIL SECTION OF A MOTOR VEHICLE

(71) Applicant: HELLA GMBH & CO. KGAA, Lippstadt (DE)

(72) Inventors: Konrad Hesse, Geseke (DE); Carsten Hohmann, Warstein (DE); Martin Mügge, Geseke (DE); Christopher Reike, Paderborn (DE); Philip Stroop, Schloß Holte-Stukenbrock (DE)

(21) Appl. No.: 19/577,777

(22) Filed: Mar. 25, 2026

(30) Foreign Application Priority Data
Mar. 26, 2025 (DE) 102025111686.5

(51) Int. Cl. F21S 43/249; F21S 43/00; F21S 43/14; F21S 43/19; F21S 43/20; F21S 43/235; F21S 43/239; F21S 43/245; F21S 43/31; F21W 103/20; F21W 103/35; F21W 103/40; F21W 103/45; F21Y 115/10

(52) U.S. Cl. CPC F21S 43/249; F21S 43/14; F21S 43/195; F21S 43/239; F21S 43/245; F21S 43/253; F21S 43/265; F21S 43/315; F21S 43/601; F21W 2103/20; F21W 2103/35; F21W 2103/40; F21W 2103/45; F21Y 2115/10

(57) ABSTRACT

A lighting device for a motor vehicle is provided. The lighting device includes a plurality of light sources, a light guide, and a cover lens. Light generated by the light sources enters the light guide through an entry surface, exits the light guide through an exit surface, and exits the lighting device through the cover lens. The lighting device generates light functions of a tail light, a brake light, and a turn signal. The exit surface serves as an illuminated surface for the light functions of the brake light and the turn signal, and the illuminated surface has an area of at least 50 cm². The lighting device may include an arrangement of optical components in which a retroreflector is arranged behind the light guide, such that light passes through the light guide, impinges on the retroreflector, is reflected back, and passes through the light guide again.

### CROSS-REFERENCE TO RELATED APPLICATIONS

This application claims the benefit of German Patent Application 10-2025-111-686.5, filed Mar. 26, 2025, the disclosure of which is incorporated by reference in its entirety.

### FIELD OF THE INVENTION

The present invention relates to an arrangement of optical components for a lighting device for a motor vehicle and to a lighting device for the tail section of a motor vehicle.

### BACKGROUND OF THE INVENTION

A lighting device of the above-mentioned type is known from DE 10-2022-129-705 A1. The lighting device described therein comprises a plurality of light sources, a planar light guide having an entry surface and at least one exit surface, and a cover plate, wherein the lighting device is configured such that the light generated by the light sources enters the light guide at least partially through the entry surface, exits at least partially from the at least one exit surface and exits the lighting device at least partially through the cover lens. The lighting device is configured to generate the light functions of a tail light, a brake light, and a turn signal.

Rear lamps are required by law on vehicles in order to make the vehicle generally visible during the day, at dusk, and at night, and to make other road users aware of the driving status and movement of the vehicle. This can be done, for example, by displaying the brake signal or by activating the turn signal or, when reversing, by switching on the reversing light.

At the same time, the rear lamps are an important design element for vehicle designers when it comes to the overall design of the vehicle, for creating a brand-typical appearance, or for attracting attention and influencing purchasing decisions.

As developments in automotive lighting technology progress, in particular with lamp embodiments having outer lenses without integrated optical elements that allow a view of the internal design of the rear lamp, and through the use of LED technology with very small LED light sources that offer new optical possibilities, for example in conjunction with light guide technology, the design of the rear lamp itself has also become an important task. The lighting designer has also developed his own field of work in this area.

However, the task of designing a rear lamp for vehicle design and utilizing the possibilities of the technologies has led to an increase in the size of the rear lamps as well as a multiplication of the complexity and number of components. In addition to the necessary optical components, numerous decorative components such as trims, additional elements, decorative elements, and the like are usually also installed.

The individual signal functions are often implemented with multiple elements arranged next to each other, wherein the various signal functions are installed next to each other or also nested one behind the other. This requires a correspondingly large installation space, large components, and therefore, a large amount of material. Due to the large number of components, many injection molding tools are also required, which also means a high expenditure of resources in terms of material and energy, as well as in the manufacture of the components and in assembly.

The use of LED light sources in combination with light guide technology also allows the arbitrary shaping of the light guides and thus of the light signature. This offers lighting and vehicle designers interesting design possibilities, but also means a great deal of expenditure in the preparation, manufacture and assembly of the components.

### SUMMARY OF THE INVENTION

Based on this design, the problem underlying the present invention is the creation of a lighting device of the type mentioned at the beginning that is simple, resource-saving and compact, and at the same time meets the legal requirements for the light functions to be generated. Furthermore, an arrangement of the type mentioned at the beginning is to be created that enables a compact design of a lighting device.

According to the invention, this is achieved by an arrangement of the type mentioned at the beginning, having the features of the disclosed embodiments, and by a lighting device of the type mentioned at the beginning, having the features set forth herein.

According to one embodiment, the arrangement comprises a light guide and a retroreflector that has a front side and a rear side, wherein the retroreflector is configured to reflect light impinging on the front side of the retroreflector from a first direction back in a second direction that is opposite to the first direction, wherein the front side of the retroreflector faces the light guide, and wherein the arrangement is configured such that light impinging on the light guide passes through the light guide, that the light that passes through the light guide impinges on the retroreflector, that the light impinging on the retroreflector is reflected back by the retroreflector, and that the light reflected back by the retroreflector passes through the light guide. This means that the retroreflector can be integrated into the optical concept of a lighting device without having to provide additional installation space for the retroreflector alongside the illuminated surfaces for the other light functions. The retroreflector therefore does not have to be arranged as a separate element on the vehicle in a different position. At the same time, the retroreflector is at least partially concealed or hidden. In particular, when the retroreflector is installed in the lighting device as a red-colored reflector lens, the retroreflector acts as a dark element and is not immediately perceived by an observer.

The retroreflector can be configured such that the reflection takes place on the front side, in particular on the outer side of the front side of the retroreflector. Alternatively, the retroreflector can be configured such that the reflection takes place on at least one reflective surface of the retroreflector that is arranged behind the front side, in particular on an inner surface of the retroreflector.

According to another embodiment, it is provided that the exit surface of the at least one light guide serves at least partially as an illuminated surface for the light functions of the brake light and the turn signal, wherein the illuminated surface for the light functions of the brake light and the turn signal has an area of at least 50 cm². This means that the illuminated surface for the light functions of the brake light and the turn signal thus has the minimum size required by law in the USA. Although the optical concept of the lighting device is implemented in a very compact manner and with few components, the required signal functions can be provided and implemented from the optical concept.

The result is an optical concept for a simple, resource-saving and sustainable lamp design that still offers vehicle and lighting designers a wide range of design options thanks to different optical embodiments. At the same time, a compact design is realized in order to provide an adequate lighting device with an appealing design using just a few components.

According to another embodiment, it is provided that the lighting device comprises an arrangement according to the invention.

It is possible that the at least one light guide has a longitudinal direction and a transverse direction perpendicular thereto and a depth perpendicular to the longitudinal direction and to the transverse direction, wherein the extent of the light guide in the longitudinal direction is greater than in the transverse direction and the extent in the transverse direction is greater than in the direction of the depth, wherein the at least one light guide has two end faces at opposite ends in the longitudinal direction, two narrow surfaces extending at least partially in the longitudinal direction, and two wide surfaces extending in the longitudinal direction, wherein the entry surface of the at least one light guide is formed on one of the narrow surfaces of the at least one light guide extending in the longitudinal direction, and wherein the exit surface of the at least one light guide is formed on one of the wide surfaces of the at least one light guide extending in the longitudinal direction.

It may be provided that the light sources are designed as light-emitting diodes that are arranged in particular on one or more printed circuit boards. The printed circuit boards with the LEDs are advantageously positioned at the side or inserted into the rear lamp from the side. This means that a maximum surface area is available for the light guide signal function, even though the at least one light guide or each of the light guides is, for example, designed only for the required minimum size for the USA of 50 cm².

It is possible that the narrow surface of the at least one light guide facing away from the entry surface meets the exit surface at an angle not equal to 90°, such that the illuminated surface formed by the exit surface is enlarged, in particular wherein the angle is between 15° and 75°, preferably between 30° and 60°, for example approximately 45°. The main portion of the light coupled laterally into the entry surface can be guided through the light guide by means of total internal reflection at the boundary surfaces and reflected forward at the outer chamfer. This portion of light reflected by the angled narrow surface and exiting from the exit surface can generate a large portion of the light distribution for the desired signal function, for example, for a tail light, a brake light, or a turn signal. The exit surface of the light guide can have a micro-scattering optic for scattering the light in the projection of the chamfer surface, such as a micro-pillow optic or a laser-generated diffuser structure or micro-optic.

It can be provided that the at least one light guide has a structuring on the exit surface and/or on the wide surface opposite the exit surface, in particular wherein the structuring is provided only in partial regions, preferably wherein the density of the structuring increases starting from the entry surface up to the narrow surface facing away from the entry surface of the at least one light guide. The structuring can also be a graphic, for example. Thanks to the structuring, the illuminated surface can comply with legal regulations and be suitable, for example, for the US homologation. In particular, a small portion of the light coupled laterally into the entry surface is not reflected by the angled narrow surface but is emitted from the exit surface by the structuring in order to achieve the required minimum illuminated surface. The increasing density of the structuring starting from the entry surface can contribute to the comparatively uniform illumination of the exit surface of the light guide. In particular, the structuring does not consist of printing because this is not sustainable and is difficult to recycle, but is created by a microstructure or micro-optic. This can be a laser-generated structure or a laser-generated micro-optic, for example. The structuring or the graphic can be individually customized and can support a plurality of design concepts. It can also include logos or lettering for further customization. It can be placed on the back side and/or the front side of the light guide.

It is possible that the extent of the at least one light guide increases in the depth perpendicular to the longitudinal direction and to the transverse direction, starting from the entry surface in the direction of the narrow surface facing away from the entry surface. This means that the light guide deviates from a plate-shaped design in the functional region and has surfaces that are arranged at an angle to each other, for example. This design can increase the efficiency of the system because the coupled light is better aligned for reflection on the chamfer surface or the angled narrow surface.

It can be provided that at least one first and at least one second of the light sources differ from each other in terms of the color of the light they generate in order to realize different signal functions. The light-emitting diodes can be provided as 1-chip LEDs if, for example, only single-color red signal functions such as a tail light and a brake light are implemented, or as 2-chip LEDs with a red and an amber chip for efficient illumination of the light guide for both red signal functions such as a tail light and a brake light and for the amber turn signal. For a US version, only red LEDs can be used because a combined tail/brake/turn signal in red is possible there. Alternatively, red and amber 1-chip LEDs can also be positioned very close to each other.

It is possible that the lighting device comprises a plurality of coupling optics, in particular wherein one of the coupling optics is arranged between each of the light sources and the entry surface of the at least one light guide. This ensures efficient coupling of the light emitted by the light-emitting diodes into the entry surface of the light guide.

It may be provided that the lighting device is configured to generate the light function of a rear fog light and/or the light function of a reversing light. At least one light source can be provided for generating the light function of a rear fog light and/or the light function of a reversing light, wherein no light guide is provided between this at least one light source and the cover lens, but rather an optical lens for shaping the light emitted by the at least one light source for the rear fog light and/or the reversing light, in particular wherein the cover lens has a structuring in a region provided for the passage of the light emitted by the optical lens. This structuring can be designed as a scatter optic or as a small micro-pillow optic.

It is possible that the lighting device has an extent of between 20 mm and 130 mm in the depth perpendicular to the longitudinal direction and to the transverse direction of the at least one light guide and/or that the exit surface of the light guide has an extent of between 20 mm and 60 mm in the transverse direction and an extent of between 90 mm and 300 mm in the longitudinal direction. This results in a very compact design of the lighting device.

### BRIEF DESCRIPTION OF THE DRAWINGS

The invention is explained in more detail below with reference to the accompanying drawings. In the drawings:

FIG. 1 is a view of a tail section of a motor vehicle with a first embodiment of a lighting device according to the invention;

FIG. 2 is a schematic front view of a second embodiment of a lighting device according to the invention;

FIG. 3 is a schematic front view of a third embodiment of a lighting device according to the invention;

FIG. 4 is a schematic front view of a fourth embodiment of a lighting device according to the invention;

FIG. 5 is a schematic front view of a fifth embodiment of a lighting device according to the invention;

FIG. 6 is a top view of the lighting device according to FIG. 1;

FIG. 7 is a perspective front view of the lighting device according to FIG. 1;

FIG. 8 is a perspective front view of the lighting device according to FIG. 1 without the cover lens, corresponding to FIG. 7;

FIG. 9 is an outer side view of the lighting device according to FIG. 1;

FIG. 10 is an inner side view of the lighting device according to FIG. 1;

FIG. 11 is a perspective exploded view of the lighting device according to FIG. 1;

FIG. 12 is a further perspective exploded view of the lighting device according to FIG. 1;

FIG. 13 is a perspective view of a detail of the lighting device according to FIG. 1;

FIG. 14 is a sectional view through a portion of the lighting device according to FIG. 1 with light beams shown;

FIG. 15 is a sectional view through a portion of a sixth embodiment of a lighting device according to the invention;

FIG. 16 is a perspective view of a further detail of the lighting device according to FIG. 1;

FIG. 17 is a perspective view of a further detail of the lighting device according to FIG. 1;

FIG. 18 is a perspective front view of portions of the lighting device according to FIG. 1 without a cover lens;

FIG. 19 is a perspective rear view of portions of the lighting device according to FIG. 1;

FIG. 20 is an enlarged perspective front view of portions of the lighting device according to FIG. 1 without a cover lens; and

FIG. 21 is an enlarged perspective rear view of portions of the lighting device according to FIG. 1.

In the figures, identical or functionally identical parts are marked with the same reference symbols.

### DETAILED DESCRIPTION

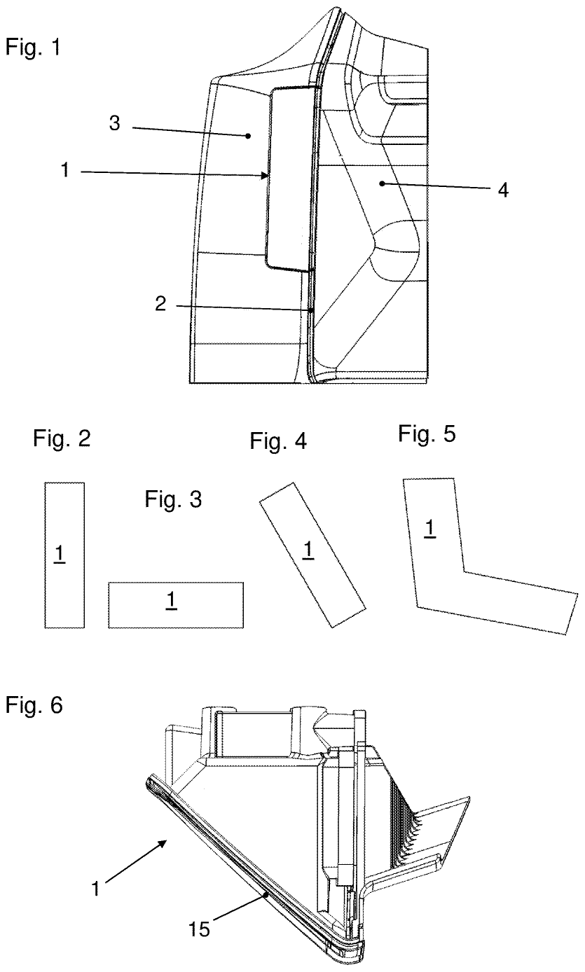

The illustrated embodiments of a lighting device are intended for installation in the tail section of a motor vehicle. FIG. 1 shows an exemplary installation of a lighting device 1 that is arranged along a parting line 2 between the outer corner body element 3 and the tailgate 4. The lighting device 1 is vertically oriented.

FIG. 2 to FIG. 5 show schematic examples of lighting devices 1 having different outlines from one another. These lighting devices 1 are each oriented differently, for example, vertically (FIG. 2), horizontally (FIG. 3), obliquely (FIG. 4), or angled (FIG. 5). Other outlines, such as curved outlines, are also possible.

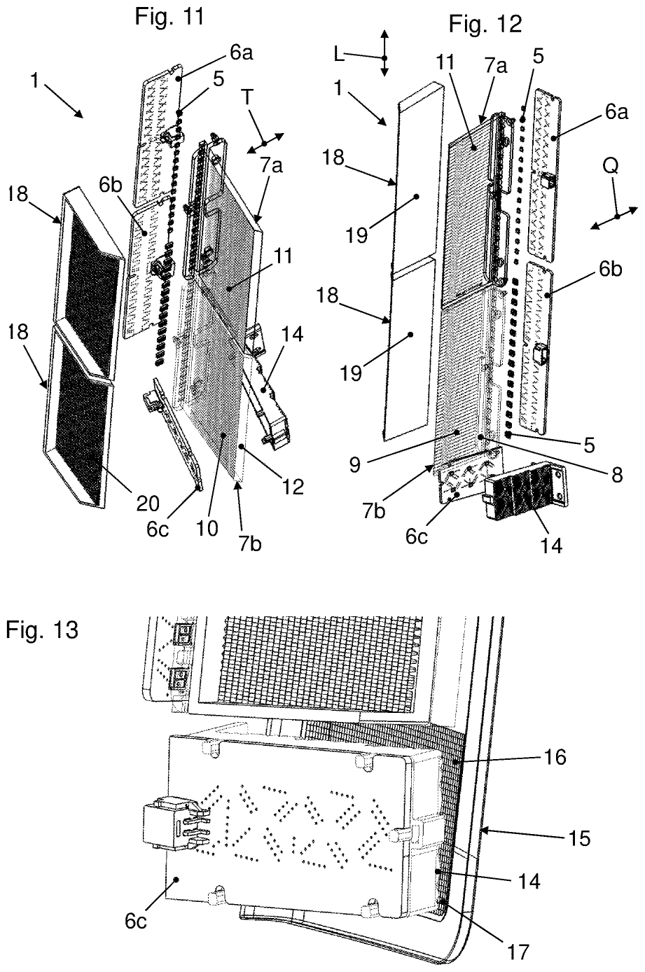

The illustrated embodiments of the lighting device 1 comprise a plurality of light sources 5 in the form of light-emitting diodes. The light-emitting diodes can be arranged on multiple separate printed circuit boards 6a, 6b (see FIG. 11 and FIG. 12). The LEDs can be provided as 1-chip LEDs if, for example, only single-color red signal functions are implemented, or as 2-chip LEDs having a red chip and an amber chip for both red signal functions, such as tail light and brake light, as well as for the amber turn signal.

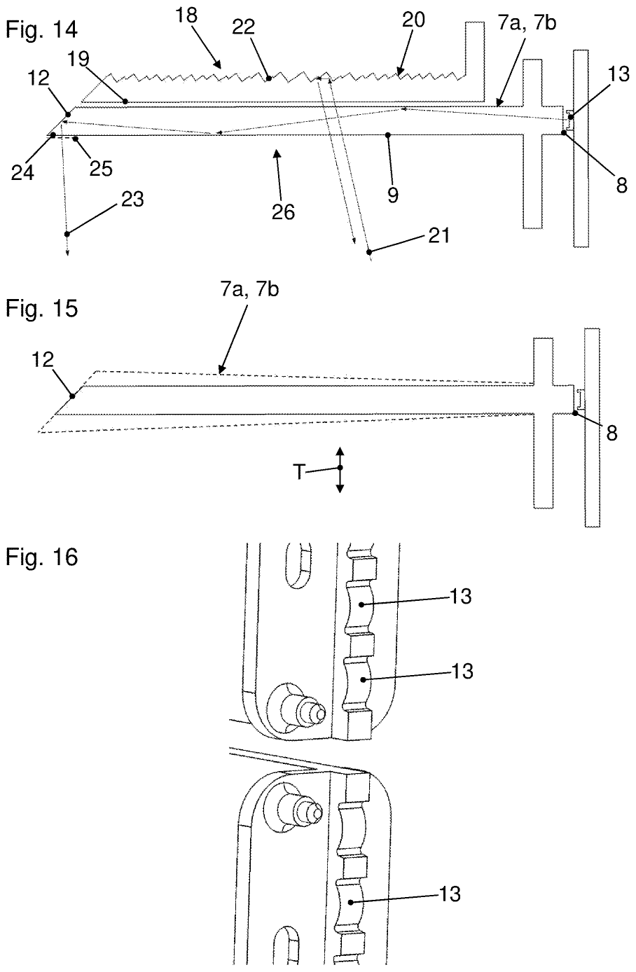

The illustrated embodiments of the lighting device 1 further comprise two light guides 7a, 7b, each having an entry surface 8 and an exit surface 9 (see FIG. 11, FIG. 12, and FIG. 14). It is entirely possible to provide only one light guide 7a, 7b or more than two light guides 7a, 7b.

Each of the light guides 7a, 7b has a longitudinal direction L and a transverse direction Q perpendicular to it, as well as a depth T perpendicular to the longitudinal direction L and to the transverse direction Q (see FIG. 11 and FIG. 12). The extent of the light guides 7a, 7b in the longitudinal direction L is greater than in the transverse direction Q, and the extent in the transverse direction Q is greater than in the direction of the depth T, wherein each of the light guides 7a, 7b has two end faces at opposite ends in the longitudinal direction L, two narrow surfaces extending at least partially in the longitudinal direction L, and two wide surfaces extending in the longitudinal direction L, wherein the entry surface 8 of the light guides 7a, 7b is formed on one of the narrow surfaces extending in the longitudinal direction L, and wherein the exit surface 9 of the light guides 7a, 7b is formed on one of the wide surfaces extending in the longitudinal direction.

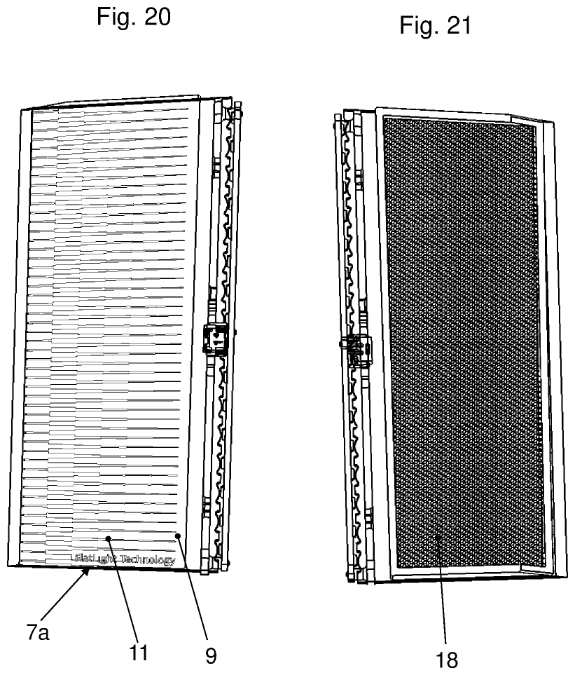

The light guides 7a, 7b have a structuring 11 on the exit surface 9 and on the wide surface 10 opposite the exit surface 9 (see FIG. 11, FIG. 12, FIG. 17, and FIG. 20). The structuring 11 can be provided only in partial regions. Furthermore, the density of the structuring 11 can increase from the entry surface 8 toward the narrow surface 12 facing away from the entry surface 8 of the light guide 7a, 7b (see also FIG. 14).

The upper light guide 7a in FIG. 12 and the upper light sources 5 in FIG. 12 are intended for generating the light functions of a tail light and a brake light. The lower light guide 7b in FIG. 12 and the middle light sources 5 in FIG. 12 are intended for generating the light functions of a tail light, a brake light, and a turn signal.

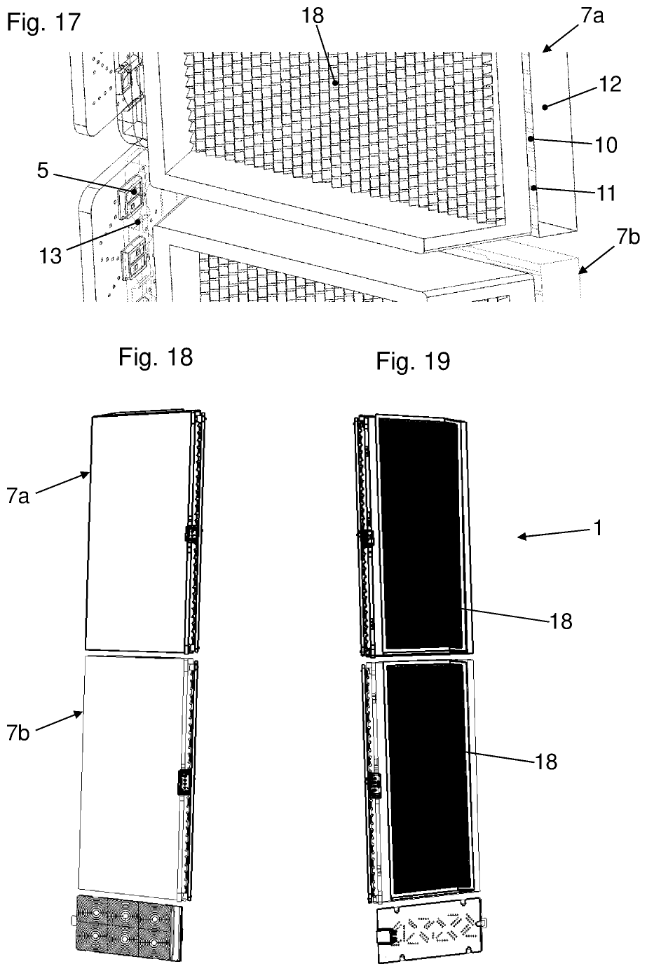

The lighting device further comprises a plurality of coupling optics 13 (see FIG. 16). One of the coupling optics 13 is arranged between each of the light sources 5 and the entry surface 8 of the light guide 7a, 7b.

FIG. 12 also shows a printed circuit board 6c below the lower light guide 7b, on which further light-emitting diodes (not shown) serving as light sources are arranged. These light sources are not assigned to a light guide, but an optical lens 14 for shaping the light emitted by the light-emitting diodes arranged on the printed circuit board 6c. Fresnel lenses, for example, are arranged on the optical lens 14.

The LEDs arranged on the printed circuit board 6c and the optical lens 14 are intended for generating the light functions of a rear fog light or a reversing light. In particular, a first lighting device 1 arranged on a first side of the motor vehicle can be configured to generate the light function of a rear fog light, whereas a second lighting device 1 arranged on a second side of the motor vehicle can be configured to generate the light function of a reversing light.

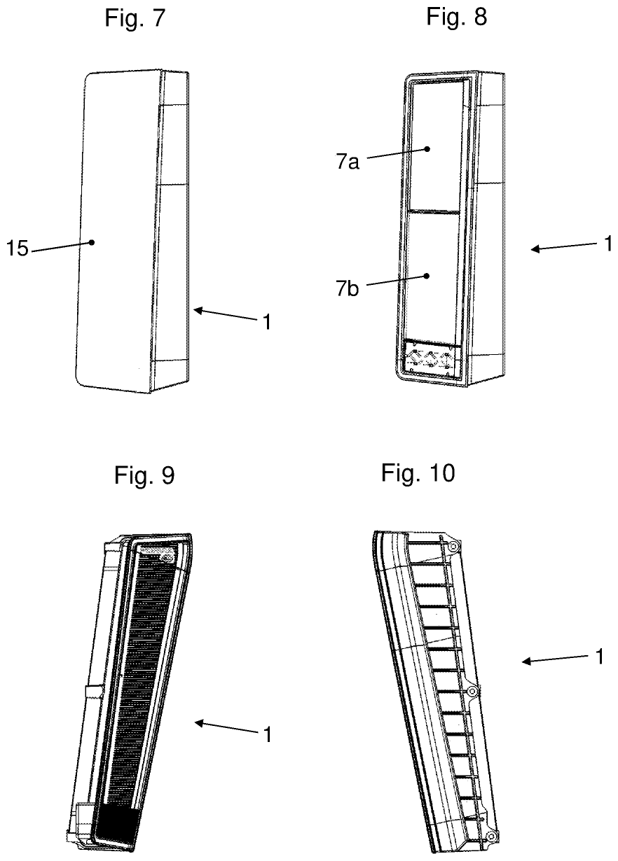

The illustrated embodiments of the lighting device 1 further comprise a cover lens 15 (see FIG. 7 and FIG. 13). The lighting device is configured such that the light generated by the light sources 5 enters the at least one light guide 7a, 7b at least partially through the entry surface 8, exits the light guide 7a, 7b through the exit surface 9 and exits the lighting device through the cover lens 15.

The cover lens 15 is unstructured except for a region 16 that is intended for the light of the light function of a rear fog light or a reversing light to pass through (see FIG. 13). In the region 16 that is intended for the passage of the light emitted by the optical lens 14, the cover lens 15 has a structuring 17. This structuring can be designed as a scatter optic or as a small micro-pillow optic.

The lighting device 1 further comprises a retroreflector 18. The retroreflector 18 has a front side 19 and a rear side 20, wherein the retroreflector 18 is configured to reflect light 21 impinging on the front side 19 of the retroreflector 18 from a first direction back in a second direction that is opposite to the first direction. The front side 19 of the retroreflector 18 faces the light guide 7a, 7b. This forms an arrangement 26 according to the invention (see FIG. 14, FIG. 11, and FIG. 12), which is set up such that light 21 impinging on the light guide 7a, 7b passes through the light guide 7a, 7b, that the light 21 passing through the light guide 7a, 7b impinges on the retroreflector 18, that the light 21 impinging on the retroreflector 18 is reflected back by the latter, and that the light 21 reflected back by the retroreflector 18 passes through the light guide 7a, 7b.

The retroreflector 18 is designed in such a way that the light 21 impinging on it enters the retroreflector 18 through the front side 19 and is totally reflected by suitable reflective structures 22 formed on the rear side 20.

FIG. 14 illustrates, on the one hand, a beam path of light 21 that impinges on the retroreflector 18 through the light guide 7a, 7b and is reflected back by it and, on the other hand, a beam path of light 23 that originates from the light source 5 and enters the entry surface 8 of the light guide 7a, 7b through the coupling optics 13. The light guide 7a, 7b has a narrow surface 12 facing away from the entry surface 8 that forms an angle not equal to 90° with the exit surface 9 of the light guide 7a, 7b, such that the illuminated surface formed by the exit surface 9 is enlarged. In the exemplary embodiment shown, the angle is approximately 45°.

As a result, a large portion of the light 23 entering the light guide 7a, 7b through the entry surface 8 is totally internally reflected at the narrow surface 12 and then exits from an end section 24 of the exit surface 9 facing away from the entry surface 8. This end section 24 of the exit surface 9 of the light guide 7a, 7b can have a micro-scattering optic 25 indicated by a dashed line in FIG. 14 for scattering the light, such as a micro-pillow optic or a laser-generated diffuser structure or micro-optic. A smaller portion of the light 23 entering the light guide 7a, 7b through the entry surface 8 is deflected by the structurings 11 before it hits the narrow surface 12, such that it exits through the exit surface 9.

In the embodiment of the lighting device 1 shown as a dashed line in FIG. 15, the extent of the light guide 7a, 7b increases in the depth T perpendicular to the longitudinal direction L and to the transverse direction Q starting from the entry surface 8 in the direction of the narrow surface 12 facing away from the entry surface 8. This means that the light guide 7a, 7b deviates from a plate-shaped design in the functional region and has, for example, surfaces that are arranged at an angle relative to one another.

### LIST OF REFERENCE SYMBOLS

1 lighting device
2 parting line between the outer corner body element and the tailgate of a motor vehicle
3 outer corner body element
4 tailgate
5 light source
6a, 6b, 6c printed circuit board
7a, 7b light guide
8 entry surface of the light guide
9 exit surface of the light guide
10 wide surface of the light guide opposite the exit surface
11 structuring of the light guide
12 narrow surface of the light guide opposite the entry surface
13 coupling optics
14 optical lens
15 cover lens
16 region of the cover lens
17 structuring of the cover lens
18 retroreflector
19 front side of the retroreflector
20 rear side of the retroreflector
21 light impinging on the retroreflector
22 reflective structure of the retroreflector
23 light emitted by the light source
24 end section of the exit surface
25 micro-scattering optic in the end section
26 arrangement of the light guide in front of the retroreflector
L longitudinal direction of the light guide
Q transverse direction of the light guide
T depth of the light guide

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. An arrangement of optical components for a lighting device for a motor vehicle, the arrangement comprising:
a light guide; and
a retroreflector having a front side and a rear side,
wherein the retroreflector is configured to reflect light impinging on the front side of the retroreflector from a first direction back in a second direction opposite to the first direction,
wherein the front side of the retroreflector faces the light guide, and
wherein the arrangement is configured such that light impinging on the light guide passes through the light guide, impinges on the retroreflector, is reflected by the retroreflector, and passes through the light guide again.

2. The arrangement according to claim 1, wherein the retroreflector is configured such that reflection takes place on the front side of the retroreflector.

3. The arrangement according to claim 1, wherein the retroreflector is configured such that reflection takes place on at least one reflective surface arranged behind the front side of the retroreflector.

4. A lighting device for a tail section of a motor vehicle, the lighting device comprising:
a plurality of light sources;
at least one light guide having an entry surface and an exit surface; and
a cover lens, wherein the lighting device is configured such that light generated by the plurality of light sources enters the at least one light guide at least partially through the entry surface, exits the at least one light guide through the exit surface, and exits the lighting device through the cover lens, wherein the lighting device is configured to generate light functions of a tail light, a brake light, and a turn signal, wherein the exit surface of the at least one light guide serves at least partially as an illuminated surface for the light functions of the brake light and the turn signal, and wherein the illuminated surface has an area of at least 50 cm².

5. The lighting device according to claim 4, wherein the lighting device further includes an arrangement comprising:
a light guide; and
a retroreflector having a front side and a rear side,
wherein the retroreflector is configured to reflect light impinging on the front side of the retroreflector from a first direction back in a second direction opposite to the first direction,
wherein the front side of the retroreflector faces the light guide, and
wherein the arrangement is configured such that light impinging on the light guide passes through the light guide, impinges on the retroreflector, is reflected by the retroreflector, and passes through the light guide again.

6. The lighting device according to claim 4, wherein:
the at least one light guide has a longitudinal direction, a transverse direction perpendicular to the longitudinal direction, and a depth perpendicular to the longitudinal direction and the transverse direction;
an extent of the at least one light guide in the longitudinal direction is greater than an extent in the transverse direction, and the extent in the transverse direction is greater than an extent in the depth;
the at least one light guide has two end faces at opposite ends in the longitudinal direction, two narrow surfaces extending at least partially in the longitudinal direction, and two wide surfaces extending in the longitudinal direction;
the entry surface is formed on one of the narrow surfaces; and
the exit surface is formed on one of the wide surfaces.

7. The lighting device according to claim 6, wherein the plurality of light sources comprise light-emitting diodes arranged on one or more printed circuit boards.

8. The lighting device according to claim 6, wherein the narrow surface of the at least one light guide that faces away from the entry surface forms an angle not equal to 90° with the exit surface such that the illuminated surface formed by the exit surface is enlarged.

9. The lighting device according to claim 6, wherein the at least one light guide includes a structuring on at least one of the exit surface or a broad surface opposite the exit surface.

10. The lighting device according to claim 6, wherein an extent of the at least one light guide in the depth increases from the entry surface toward the narrow surface that faces away from the entry surface.

11. The lighting device according to claim 4, wherein the plurality of light sources includes at least one first light source and at least one second light source that differ from one another with respect to color of emitted light.

12. The lighting device according to claim 4, wherein the lighting device further comprises a plurality of coupling optics, wherein each of the plurality of coupling optics is arranged between a respective one of the plurality of light sources and the entry surface of the at least one light guide.

13. The lighting device according to claim 4, wherein the lighting device is further configured to generate at least one of a rear fog light function or a reversing light function.

14. The lighting device according to claim 13, wherein:
the lighting device further comprises at least one additional light source configured to generate the at least one of the rear fog light function or the reversing light function;
no light guide is disposed between the at least one additional light source and the cover lens; and
an optical lens is disposed to shape light emitted by the at least one additional light source.

15. The lighting device according to claim 4, wherein the lighting device has an extent in the depth between 20 mm and 130 mm, or wherein the exit surface of the at least one light guide has an extent in the transverse direction between 20 mm and 60 mm and an extent in the longitudinal direction between 90 mm and 300 mm.
